(19) United States
(12) Patent Application Publication
(10) Pub. No.: US 2008/0072308 A1
(43) Pub. Date: Mar. 20, 2008

(54) Terminal apparatus security management apparatus and method

(75) Inventor: Katsumi Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/646,563

(22) Filed: Dec. 28, 2006

(30) Foreign Application Priority Data
Aug. 22, 2006 (JP) 2006-224975

(51) Int. Cl. G06F 15/16

(52) U.S. Cl. 726/12

(57) ABSTRACT

A security management apparatus temporarily holds a session establishment request by a terminal apparatus 3 then determines permission or refusal of the session establishment request based on terminal management information. If permission is determined, the apparatus determines whether or not the security state of the source terminal apparatus is the latest one based on security management information. If it is determined not to be the latest one, then the apparatus sends out a session establishment request in which the terminal apparatus and a security information management apparatus are set as the source and the destination. After that, when update of the security of the terminal apparatus is notified, the held session establishment request by the terminal apparatus is sent out. On the other hand, if the security state is determined to be the latest one, the held session establishment request by the terminal apparatus is sent out.

### CROSS-REFERENCE TO RELATED APPLICATION

This application claims priority from Japanese patent application Serial no. 2006-224975 filed Aug. 22, 2006, the contents of which are incorporated by reference herein.

### BACKGROUND OF THE INVENTION

1. Field of the Invention

The present invention relates to a security management apparatus for a terminal apparatus connected to a network, and in particular to a security management apparatus for automatically determining the security state when a terminal apparatus requests establishment of a session and causing security information to be forcibly updated.

2. Description of the Related Art

Data communication processing by a terminal apparatus connected to a network may possibly be a security hole. In order to prevent such a situation, Patent Document 1: Japanese Patent Laid-Open No. 06-244833 is proposed a method in which a receiving security level is set and held for each communication counterpart in advance, an information security level is set for information to be transferred when a terminal apparatus connects to a network, the security level of a communication counterpart and the security level of the information to be transferred are compared with each other, and communication is enabled only when the security level of the communication counterpart is a predetermined level or above.

### SUMMARY OF THE INVENTION

It is necessary to update a security program or definition information used for security processing installed in a terminal apparatus which connects to a network, as appropriate to keep the latest state.

In the actual situation, it is common that the security state of a terminal apparatus is periodically updated based on a user's determination. There may be a case where a security program is automatically updated or a case where periodic update of security information is executed as an operation rule, depending on environmental settings for a terminal apparatus. The work of making environmental settings or application of an operation rule itself is a work performed manually. Therefore, such a situation frequently occurs that, in some terminal apparatuses among multiple terminal apparatuses, some settings are dropped or the operation rule is not complied with. If a terminal apparatus is connected to a network while the security state is not updated, the terminal apparatus may be subject to virus infection, attack to vulnerability and the like. Furthermore, there may be a case where a trouble is caused in the operation of the entire network by such a terminal apparatus with vulnerable security.

Accordingly, it is necessary to confirm update of a security program installed in a terminal apparatus at the timing when the program is used (or required).

The applicant has made an invention in which the version number of a security program in a terminal apparatus is checked, for example, by a router or an application server when the terminal apparatus attempts to connect to a network, connection to the network is not permitted when the version number is not a desired one, and connection to the network is permitted after the version number is updated to the desired one (see Japanese Patent Application 2006-99674).

However, the work of updating the security state of a terminal apparatus is eventually entrusted to determination by the user of the terminal apparatus. Therefore, the user has to do a troublesome work of obtaining update data for each terminal apparatus.

The object of the present invention is to provide a technique for causing the security of a terminal apparatus to be efficiently updated, by determining the security state of the terminal apparatus connected to a network and forcibly giving a chance to acquire update information if security update is necessary.

According to the present invention, in order to maintain the security of a terminal apparatus connected to a network, judgment of necessity of security update is made by utilizing the timing of receiving a session establishment request. Furthermore, a source terminal apparatus is forcibly connected to an apparatus holding security update information, and thereby, it is possible to give a chance to update the security to the user of the terminal apparatus and efficiently secure the security of the terminal apparatus.

In order to determine the security state of a terminal apparatus connected to a network, an aspect in accordance with the present invention provides an apparatus includes 1) a security management information storage section for storing security management information indicating the latest state of the security of a terminal apparatus; 2) a session request holding section for holding a session establishment request received from a terminal apparatus in a session-request temporary-storage section; 3) a security determination section for acquiring the security state of the terminal apparatus which has originated the session establishment request held in the session-request temporary-storage section and determining whether or not the security state of the terminal apparatus is the latest one based on the security management information; and 4) a session request switching section for holding destination information about a security information management apparatus holding update information about the security of the terminal apparatus, creating and transmitting an update information acquisition session establishment request, in which the terminal apparatus and the destination information are set as the source and the destination respectively, if the security state of the terminal apparatus is not the latest one, and transmitting the session establishment request held in the session-request temporary-storage section if the security state of the terminal apparatus is the latest one.

The apparatus in accordance with the present invention is provided with the security management information storage section for storing security management information indicating the latest state of the security of a terminal apparatus. When a session establishment request is received from a terminal apparatus, the session establishment request is temporarily stored in the session-request temporary-storage section by the session request holding section. Then, the security state of the terminal apparatus which has originated the session establishment request held in the session-request temporary-storage section is acquired by the security determination section, and it is determined whether or not the security state of the terminal apparatus is the latest one based on the security management information.

When the security state of the terminal apparatus is not the latest one, an update information acquisition session establishment request in which the terminal apparatus and destination information about the security information management apparatus are set as the source and the destination, respectively, is created and transmitted by the session request switching section holding destination information about the security information management apparatus holding update information about the security of the terminal apparatus. On the other hand, if the security state of the terminal apparatus is the latest one, the session establishment request held in the session-request temporary-storage section is transmitted.

Therefore, in the case where the security state is not the latest one, such as the case where the security program of a terminal apparatus or the version number of definition information used for security processing is old, the terminal apparatus is connected to the security information management apparatus before being connected to a requesting destination. Thus, a chance to acquire security update information can be obtained, and the security of the terminal apparatus can be efficiently secured.

When an update information acquisition session establishment request is transmitted, and a notification to the effect that the security of the terminal apparatus has been updated is received, the session request switching section can perform processing for transmitting the session establishment request held in the session-request temporary storage section.

Therefore, a session establishment request is not transmitted to a desired counterpart unless it is confirmed, for example, that the terminal apparatus has downloaded update information from the security information management apparatus or that installation of the update information has been completed. Thus, the terminal apparatus can secure the latest security state before security risks increase.

Furthermore, the apparatus in accordance with the present invention may includes 5) a terminal management information storage section for storing terminal management information in which permission/refusal of a session establishment request is set for each terminal apparatus; and 6) a terminal management section for determining permission/refusal of a session establishment request stored in the session-request temporary-storage section, based on the terminal management information; wherein, if the result of determination by the terminal management section is permission, the security determination section may acquire the security state of the terminal apparatus which has originated the session establishment request held in the session-request temporary-storage section and determine whether or not the security state of the terminal apparatus is the latest one based on the security management information, and, if the result of determination by the terminal management section is refusal, the session request switching section may create and transmit an update information acquisition session establishment request in which the terminal apparatus and the destination information are set as the source and the destination.

Alternatively, the apparatus in accordance with the present invention may includes 5) a terminal management information storage section for storing the terminal management information in which the time of transmitting a session establishment request is stored for each terminal apparatus; and 6) a terminal management section for, when a session establishment request is held in the session-request temporary-storage section, acquiring the time of receiving the session establishment request, and determining permission of the received session establishment request if the receiving time is within a predetermined period after the time of transmitting the terminal management information last; wherein, if the result of determination by the terminal management section is permission, the security determination section may acquire the security state of the terminal apparatus which has originated the session establishment request held in the session-request temporary-storage section and determine whether or not the security state of the terminal apparatus is the latest one based on the security management information.

Therefore, it is possible to efficiently maintain the security of a terminal apparatus, for example, by recording a terminal apparatus with a high possibility that the security state is not the latest one in terminal management information in advance or by, when a session establishment request is received from such a terminal apparatus that the security state is considered not to be the latest one or a terminal apparatus for which security state determination has not been made for a long time, connecting the terminal apparatus immediately to the security information management apparatus to give a chance to download update information without making determination on the security state of the terminal apparatus.

The apparatus in accordance with the present invention which performs the above processing can be realized by a program installed and executed on a computer. The program which realizes the present invention can be stored in an appropriate recording medium such as a computer-readable portable medium memory, a semiconductor memory and a hard disk, and the program is provided, being recorded in such a recording medium or provided by sending/receiving with the use of various communication networks via a communication interface.

According to the present invention, it is possible to automatically determine the security state at the time of making a connection request when security risks increase. Furthermore, if security update is necessary, a terminal apparatus can be connected to a predetermined security information management apparatus holding security update information, without a manual operation being performed by the user of the terminal apparatus. For example, when a terminal apparatus in which a virus cleaning program is installed transmits a session establishment request, it is automatically determined whether or not the version number of definition information used by the virus cleaning program is the latest one. If the version of the definition information is not the latest one, then the terminal apparatus is forcibly connected to the security information management apparatus holding update data of the definition information, and thereby it is easy to obtain the update data.

Furthermore, according to the present invention, when it is notified by the security information management apparatus that the update data has been downloaded to the terminal apparatus, a session establishment request received from the terminal apparatus and held can be automatically transmitted. Therefore, on the terminal apparatus side, it is possible to save the trouble of performing connection processing which has been terminated, again after the update of security.

Furthermore, according to the present invention, when a session establishment request is received, for example, from a terminal apparatus from which a session establishment request has not been made for a long time or from a terminal apparatus the session establishment request from which has been refused with the use of setting registration, the terminal apparatus can be forcibly connected to a predetermined security information management apparatus and given a chance to update the security without making determination on the security state. Thus, it is possible to urge a terminal apparatus considered to have a security trouble to update the security and thereby secure the security of the terminal apparatus.

As described above, the present invention can efficiently and certainly maintain the state of security of a terminal apparatus which makes a connection request.

### BRIEF DESCRIPTION OF THE DRAWINGS

FIG. 1 is a diagram showing an example of configuration in an embodiment of the present invention;

FIG. 2 is a diagram showing an example of configuration of update information;

FIG. 3 is a diagram showing an example of configuration of security management information;

FIG. 4 is a diagram showing an example of configuration of terminal management information; and

FIGS. 5 and 6 are diagrams for illustrating a process flow of the present invention.

### DETAILED DESCRIPTION OF THE PREFERRED EMBODIMENTS

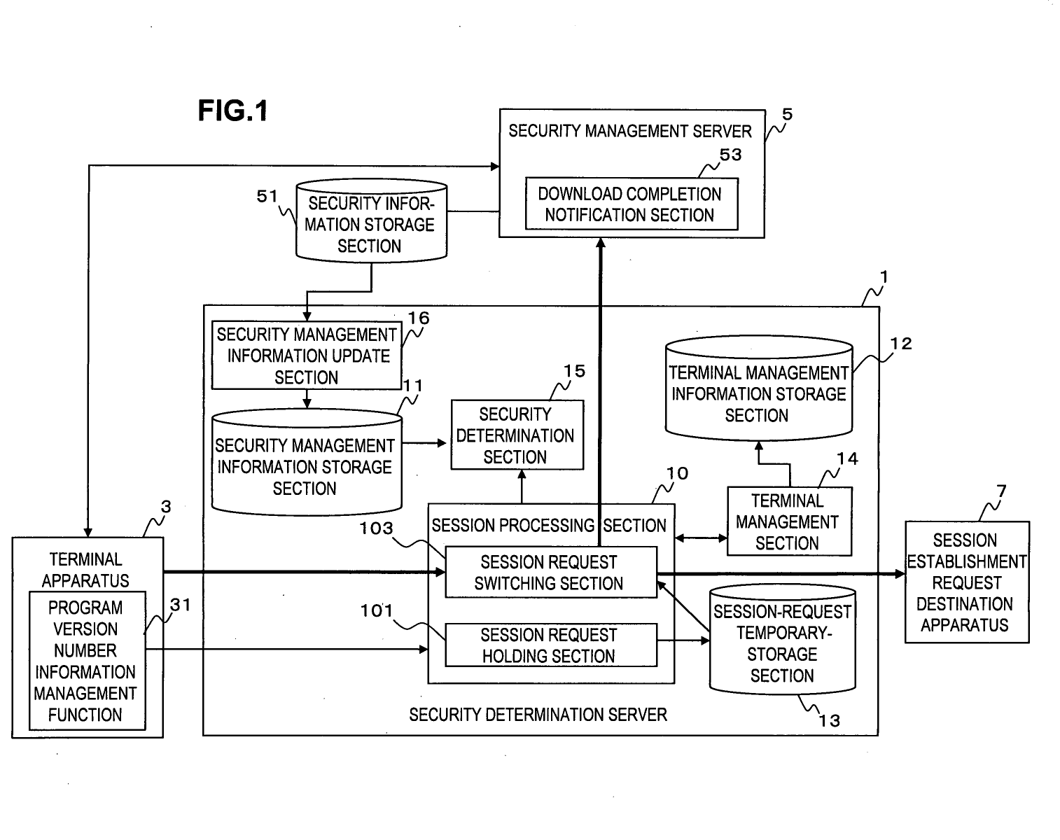

FIG. 1 shows an example of configuration in an embodiment of the present invention.

A terminal apparatus security determination apparatus (hereinafter referred to as “a security determination server”) 1 is a computer configured by a CPU, a memory, for determining the security state of a terminal apparatus 3 in response to receiving of a session establishment request from the terminal apparatus 3. The security determination server 1 can be embodied as a network router or a device arranged in a proxy server.

The security of the terminal apparatus 3 can be maintained, by a security program for performing virus cleaning processing, definition information used by the security program, and the like. The security state is also determined by the version number of the security program or the definition information.

A security information management apparatus (hereinafter referred to as “a security management server”) 5 is provided with a security information storage section 51 for storing update information about security of the terminal apparatus 3 and a download completion notification section 53 for notifying completion of download to the security determination server 1 when the update information is downloaded to the terminal apparatus 3.

The update information is program data for version up of the security program used by the terminal apparatus 3, update data of the definition information for the security program and the like.

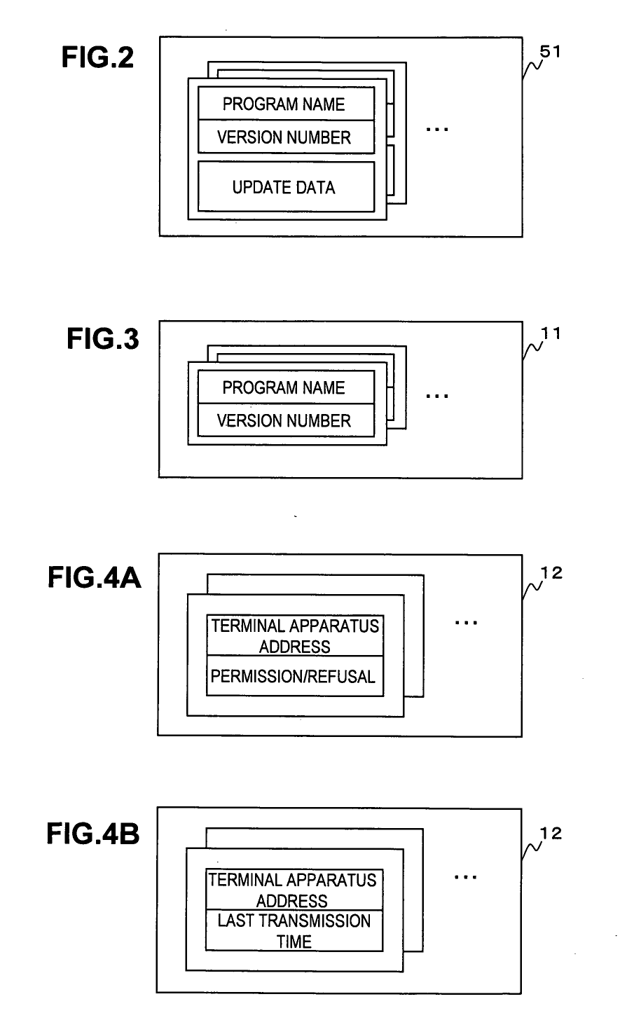

FIG. 2 shows an example of the configuration of update information stored in the security information storage section 51. In the security information storage section 51, there are stored information for identifying the security program used by the terminal apparatus 3, for example, a program name, the version number; and update data, for example, data for update of the definition information, version-up data for the security program and the like.

The security determination server 1 is provided with a session processing section 10, a security management information storage section 11, a terminal management information storage section 12, a session-request temporary-storage section 13, a terminal management section 14, a security determination section 15 and a security management information update section 16.

The session processing section 10 transmits a session establishment request packet of the terminal apparatus 3 and is provided with a session request holding section 101 and a session request switching section 103.

The session request holding section 101 stores a session establishment request packet received from the terminal apparatus 3 in the session-request temporary-storage section 13.

The session request switching section 103 switches the session establishment request packet to be transmitted, based on the result of security determination by the security determination section 15.

The session request switching section 103 holds address information about the security management server 5. If the security state of the terminal apparatus 3 is not the latest one, for example, if the version number of the definition information for the security program is not the latest one, an update information acquisition session establishment request packet, in which the address information about the terminal apparatus 3 and the address information about the security management server 5 are set as the source and the destination, is created and transmitted. Alternatively, if the version number of the definition information for security program of the terminal apparatus 3 is the latest one, then the session establishment request packet held in the session-request temporary-storage section 13 is transmitted.

If the result of determination by the terminal management section 14 to be described later is refusal of a session establishment request, then the session request switching section 103 creates and transmits an update information acquisition session establishment request packet. Furthermore, if receiving a notification of completion of downloading update information to the terminal apparatus 3, from the security management server 5 or receiving an update information installation completion notification from the terminal apparatus 3 in the case of having transmitted the update information acquisition session establishment request packet, the session request switching section 103 transmits the session establishment request packet held in the session-request temporary-storage section 13.

The security management information storage section 11 stores security management information used to manage security information used by the terminal apparatus 3.

FIG. 3 shows an example of the configuration of the security management information. The latest version number of definition information for the security program used by the terminal apparatus 3 is recorded in the security information.

The terminal management information storage section 12 stores terminal management information.

FIGS. 4A and 4B show examples of the configuration of the terminal management information. As shown in FIG. 4A, the address of the terminal apparatus 3 and whether or not processing of a session establishment request packet is possible (permission or refusal of the packet) are set for each terminal apparatus 3, in the terminal management information. Permission or refusal of a session establishment request packet is set by the administrator of the security determination server 1.

Alternatively, as shown in FIG. 4B, the address of the terminal apparatus 3 and the time when a session establishment packet is transmitted last are recorded for each terminal apparatus 3 in the terminal management information.

The session-request temporary-storage section 13 stores a session establishment request packet which has been received from the terminal apparatus 3 and in which address information about a session establishment request destination apparatus 7 is set as the destination.

The terminal management section 14 determines permission or refusal of processing of a session establishment request packet held in the session-request temporary-storage section 13 based on the terminal management information.

The terminal management section 14 determines permission or refusal of the received session establishment request packet in accordance with the setting for the terminal apparatus 3 which has originated the session establishment request packet stored in the session-request temporary-storage section 13, if the terminal management information shown in FIG. 4A is stored.

Furthermore, the terminal management section 14 acquires the time of receiving the session establishment request packet stored in the session-request temporary-storage section 13, if the terminal management information shown in FIG. 4B is stored. If the receiving time is within a predetermine period after the last transmission time recorded in the terminal management information, then “permission” of the received session establishment request packet is determined.

The security determination section 15 acquires the security state of the terminal apparatus 3 which has originated the session establishment request packet stored in the session-request temporary-storage section 13 and determines whether or not the security state of the terminal apparatus 3 is the latest one based on the security management information.

The security state of the terminal apparatus 3 is notified with the use of a program version number information management function 31 provided for the terminal apparatus 3.

If the terminal management section 14 determines “permission”, then the security determination section 15 acquires the current version number of the definition information for the security program as the security state of the terminal apparatus 3 which has originated the session establishment request packet stored in the session-request temporary-storage section 13. Then, it is determined whether or not the current version number of the definition information for the security program of the terminal apparatus 3 is the latest one based on the security management information, and hands the determination result to the session request switching section 103 of the session processing section 10.

The security management information update section 16 acquires the latest version number of the definition information for the security program as information indicting the latest state of security information to be used by the terminal apparatus 3, from the security management server 5 and updates the security management information stored in the security management information storage section 11.

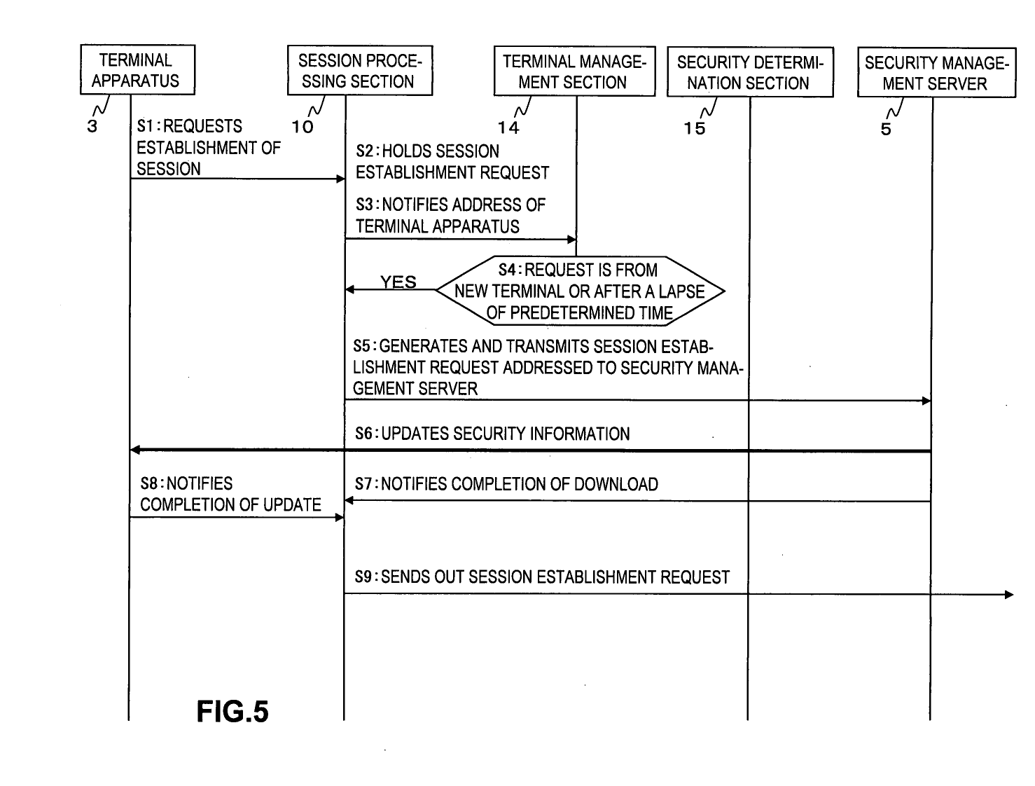

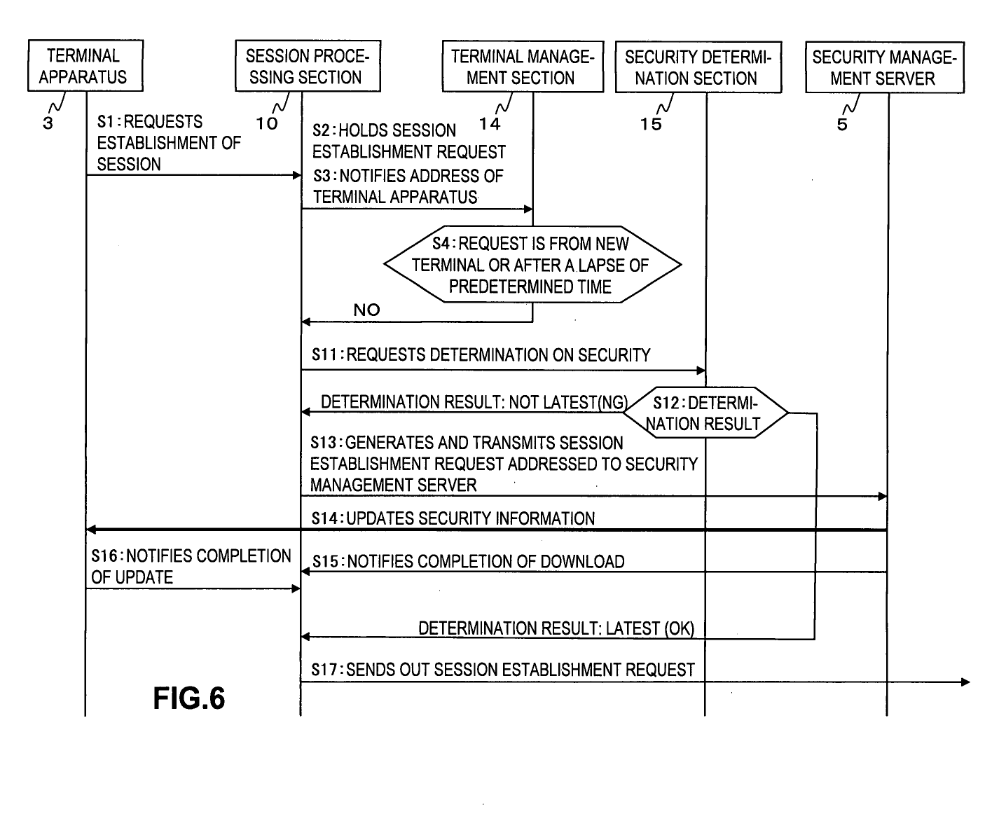

Description will be made on the process flow in the embodiment of the present invention with the use of FIGS. 5 and 6.

The processing at steps S1 to S9 will be described with the use of FIG. 5.

Step S1: The terminal apparatus 3 transmits a session establishment request packet in which the address of a session establishment request destination apparatus 7 is set as the destination.

Step S2: The session processing section 10 of the security determination server 1 stores the source address (the address of the terminal apparatus 3) and the destination address (the address of the session establishment request destination apparatus 7) in the received session establishment request packet, into the session-request temporary-storage section 13.

Step 3: The session processing section 10 notifies the address of the terminal apparatus 3 to the terminal management section 14 and inquires about permission/refusal of a session establishment request packet.

Step S4: The terminal management section 14 determines permission or refusal of the session establishment request packet with the use of the terminal management information stored in the terminal management information storage section 12. Here, it is assumed that the terminal management information shown in FIG. 4B is stored. The terminal management section 14 regards the current time as the time of receiving the session establishment request packet. If this receiving time is after a lapse of a predetermined time after the time of the last transmission stored in the terminal management information, or if the transmission time is not recorded in the terminal management information (S4: YES), then “refusal” is returned to the session processing section 10.

Step S5: When receiving “refusal”, the session processing section 10 generates and transmits an update information acquisition session establishment request packet in which the address of the terminal apparatus 3 and the address of the security management server 5 are set as the source and the destination.

Step S6: The security management server 5 receives the update information acquisition session establishment request packet, and a session with the terminal apparatus 3 is established. Then, the terminal apparatus 3 downloads the latest update data of definition information for the security program, which is stored in the security information storage section 51.

Step S7: When the terminal apparatus 3 completes download of the latest update data, the download completion notification section 53 of the security management server 5 transmits a download completion notification to the security determination server 1.

Step S8: The terminal apparatus 3 performs update of the definition information for the security program using the downloaded update data and transmits an update completion notification to the security determination server 1. The update completion notification may be notification of the version number of the definition information for the security program by the program version number information management function 31.

Step S9: The session processing section 10 receives any one of the download completion notification and the update completion notification or receives both of them. Then, a session establishment request packet in which the address of the terminal apparatus 3 and the address of the session establishment request destination apparatus 7 are set as the source and the destination is transmitted based on the source and destination addresses stored in the session-request temporary-storage section 13.

The processing at steps S11 to S17 will be described with the use of FIG. 6. The content of the processing at steps S1 to S4 shown in FIG. 6 is the same as the content of the processing at the steps denoted by the same reference numerals shown in FIG. 5.

At the processing at step S4, if the session establishment request packet receiving time (current time) is within the predetermined time after the time of the last transmission stored in the terminal management information (S4: NO), then the terminal management section 14 returns “permission” to the session processing section 10.

Step S11: When receiving “permission”, the session processing section 10 requests the security determination section 15 to perform determination processing.

Step S12: The security determination section 15 acquires the version number of the definition information for the security program by the program version number information management function 31 of the terminal apparatus 3. Then, it is determined whether or not the current version number is the latest one based on the security management information.

Step S13: If the security determination section 15 determines that the current version number is not the latest one (determination result: NG), then an update information acquisition session establishment request packet in which the address of the terminal apparatus 3 and the address of the security management server 5 are set as the source and the destination is generated and transmitted.

Step S14: The security management server 5 receives the update information acquisition session establishment request packet, and a session with the terminal apparatus 3 is established. The terminal apparatus 3 downloads the latest update data in the security information storage section 51.

Step S15: the download completion notification section 53 of the security management server 5 transmits a notification of completion of download of the update data onto the terminal apparatus 3, to the security determination server 1.

Step S16: The terminal apparatus 3 transmits a security program update completion notification to the security determination server 1.

Step S17: If the security determination section 15 determines that the current version number of the security program of the terminal apparatus 3 is the latest one (determination result: OK), then the session processing section 10 transmits a session establishment request packet in which the address of the terminal apparatus 3 and the address of the session establishment request destination apparatus 7 are set as the source and the destination based on the source and destination addresses stored in the session-request temporary-storage section 13.

If permission/refusal of a session establishment request packet is set for each terminal apparatus 3 as terminal management information, as shown in FIG. 4A, and it is successively determined by the security determination section 15 that the version number of the definition information for the security program of the terminal apparatus 3 is not the latest one a predetermined number of times, then “refusal” is set by the terminal management section 14 for processing of a session establishment request packet of the terminal apparatus 3, in the terminal management information. In this case, the session processing section 10 refuses the session establishment request packet processing.

On the other hand, when the result of the determination by the security determination section 15 indicates that the version number of the security program of the terminal apparatus 3 is the latest one, the terminal management section 14 updates the setting for session establishment request packet processing in the terminal management information to be “permission”.

As described above, if it is determined by the terminal management section 14 that a predetermined time or more has elapsed after the time of transmitting a new or the last session establishment request when a session establishment request packet is received from the terminal apparatus 3, then a session request packet in which the address of the security management server 5 is set as the destination is transmitted by the session processing section 10 without making determination on security information. Therefore, the terminal apparatus 3 cannot be connected to the session establishment request destination apparatus 7 to which it originally desires to connect unless it is connected to the security management server 5 to acquire update information held in the security management server 5 and updates the security with the update information. When it is notified to the security determination server 1 that the security of the terminal apparatus 3 has been updated, connection with the session establishment request destination apparatus 7 which the terminal apparatus 3 requests is enabled.

The present invention has been described using an embodiment thereof. It goes without saying that various variations of the present invention are possible within the range of its spirit. For example, transmission history information about session establishment requests received from the terminal apparatus 3 and processed may be used as the terminal management information to be stored in the terminal management information storage section 12. The terminal management section 14 may determine permission/refusal of processing of a session establishment request based on intervals among multiple transmission times, based on this transmission history information.

What is claimed is:

1. A security management apparatus for a terminal apparatus, the security management apparatus comprising, in order to manage the security state of a terminal apparatus connected to a network:
a security management information storage section for storing security management information indicating the latest state of the security of a terminal apparatus;
a session request holding section for holding a session establishment request received from a terminal apparatus in a session-request temporary-storage section;
a security determination section for acquiring the security state of the terminal apparatus which has originated the session establishment request held in the session-request temporary-storage section and determining whether or not the security state of the terminal apparatus is the latest one based on the security management information; and
a session request switching section for holding destination information about a security information management apparatus holding update information about the security of the terminal apparatus, creating and transmitting an update information acquisition session establishment request, in which the terminal apparatus and the destination information are set as the source and the destination respectively, if the security state of the terminal apparatus is not the latest one, and transmitting the session establishment request held in the session-request temporary-storage section if the security state of the terminal apparatus is the latest one.

2. The security management apparatus for a terminal apparatus according to claim 1, wherein
when the update information acquisition session establishment request is transmitted, and a notification to the effect that the security of the terminal apparatus has been updated is received, the session request switching section transmits the session establishment request held in the session-request temporary-storage section.

3. The security management apparatus for a terminal apparatus according to claim 1, the security management apparatus comprising:
a terminal management information storage section for storing terminal management information in which permission/refusal of a session establishment request is set for each of the terminal apparatuses; and
a terminal management section for determining permission/refusal of a session establishment request held in the session-request temporary-storage section, based on the terminal management information; wherein
if the result of determination by the terminal management section is permission, the security determination section acquires the security state of the terminal apparatus which has originated the session establishment request held in the session-request temporary-storage section and determines whether or not the security state of the terminal apparatus is the latest one based on the security management information; and
if the result of determination by the terminal management section is refusal, the session request switching section creates and transmits an update information acquisition session establishment request in which the terminal apparatus and the destination information are set as the source and the destination, respectively.

4. The security management apparatus for a terminal apparatus according to claim 3, wherein
the session request switching section stores the result of determination by the terminal management section, and, if the result of determination on the terminal apparatus is refusal successively multiple times, refuses transmission of a session establishment request by the terminal apparatus.

5. The security management apparatus for a terminal apparatus according to claim 1, the security management apparatus comprising:
a terminal management information storage section for storing the terminal management information in which the time of transmitting a session establishment request is stored for each of the terminal apparatuses; and
a terminal management section for, when a session establishment request is held in the session-request temporary-storage section, acquiring the time of receiving the session establishment request, and determining permission of the received session establishment request if the receiving time is within a predetermined period after the time of transmitting the terminal management information last; wherein
if the result of determination by the terminal management section is permission, the security determination section acquires the security state of the terminal apparatus which has originated the session establishment request held in the session-request temporary-storage section and determines whether or not the security state of the terminal apparatus is the latest one based on the security management information.

6. The security management apparatus for a terminal apparatus according to claim 5, wherein
if a session establishment request is transmitted by the session request switching section, the terminal management section records the time of transmitting the session establishment request in the terminal management information.

7. The security management apparatus for a terminal apparatus according to claim 1, the security management apparatus comprising a security management information update section for acquiring input information indicating the latest state of the security of the terminal apparatus and updating the security management information stored in the security management information storage section.

8. A terminal apparatus security management method in which a security management apparatus manages the security state of a terminal apparatus connected to a network, the method comprising:
holding a session establishment request received from a terminal apparatus in a session-request temporary-storage section;
acquiring the security state of the terminal apparatus which has originated the session establishment request held in the session-request temporary-storage section, and determining whether or not the security state of the source terminal apparatus is the latest one, with reference to a security management information storage section in which security management information indicating the latest state of the security of terminal apparatuses is stored; and
by holding destination information about a security information management apparatus holding update information about the security of the terminal apparatus, creating and transmitting an update information acquisition session establishment request in which the terminal apparatus and the destination information are set as the source and the destination if the security state of the source terminal apparatus is not the latest one, and transmitting the session establishment request held in the session-request temporary-storage section if the security state of the source terminal apparatus is the latest one.

9. The security management method for a terminal apparatus according to claim 8, the method comprising:
when the update information acquisition session establishment request is transmitted, and a notification to the effect that the security of the source terminal apparatus has been updated is received, transmitting the session establishment request held in the session-request temporary-storage section.

10. The security management method for a terminal apparatus according to claim 8, the method comprising:
by having stored terminal management information in which permission/refusal of a session establishment request is set for each of the terminal apparatuses, in a terminal management information storage section, determining permission/refusal of the session establishment request held in the session-request temporary-storage section based on the terminal management information;
if the result of determination about permission/refusal of the session establishment request is permission, acquiring the security state of the terminal apparatus which has originated the session establishment request held in the session-request temporary-storage section and determining whether or not the security state of the source terminal apparatus is the latest one based on the security management information, and, if the result of determination about permission/refusal of the session establishment request is refusal, creating and transmitting an update information acquisition session establishment request in which the source terminal apparatus and the destination information are set as the source and the destination.

11. The security management method for a terminal apparatus according to claim 10, the method comprising:
holding the result of determination about permission/refusal of the session establishment request; and
if the result of determination about the source terminal apparatus is refusal successively multiple times, refusing transmission of a session establishment request by the terminal apparatus.

12. The security management method for a terminal apparatus according to claim 8, wherein
the security management apparatus comprises a terminal management information storage section for storing the terminal management information in which the time of transmitting a session establishment request is stored for each of the terminal apparatuses; and
the method comprises:
when a session establishment request is held in the session-request temporary-storage section, acquiring the time of receiving the session establishment request, and determining permission of the received session establishment request if the receiving time is within a predetermined period after the time of transmitting the terminal management information last; and
if the result of determination about the received session establishment request is permission, acquiring the security state of the terminal apparatus which has originated the session establishment request held in the session-request temporary-storage section and determining whether or not the security state of the source terminal apparatus is the latest one based on the security management information.

13. The security management method for a terminal apparatus according to claim 12, the method comprising:
if a session establishment request is transmitted by the session request switching section, recording the time of transmitting the session establishment request in the terminal management information.

14. The security management method for a terminal apparatus according to claim 8, the method comprising:
acquiring input information indicating the latest state of the security of the terminal apparatus and updating the security management information stored in the security management information storage section.
